(19) United States
(12) Patent Application Publication
(10) Pub. No.: US 2026/0019146 A1
(43) Pub. Date: Jan. 15, 2026

(54) EARTH STATION, RELAY SATELLITE, SATELLITE SYSTEM AND COMMUNICATION METHOD

(71) Applicant: Warpspace, INC., Ibaraki (JP)

(72) Inventors: Takehiko SONODA, Saitama (JP); Masanori SEKI, Ibaraki (JP)

(73) Assignee: Warpspace, INC., Ibaraki (JP)

(21) Appl. No.: 18/992,990

(22) PCT Filed: Jul. 11, 2023
(86) PCT No.: PCT/JP2023/025586

§ 371 Date: Jan. 10, 2025

(30) Foreign Application Priority Data
Jul. 11, 2022 (JP) 2022-111267

(51) Int. Cl. H04B 7/185

(52) U.S. Cl. CPC H04B 7/18517; H04B 7/18521

(57) ABSTRACT

There is provided a technique for achieving inter-satellite optical communication for a satellite having a limited calculation capability. One aspect of the present disclosure relates to an earth station, including: a data acquisition unit that acquires a predicted orbit data sequence indicative of a predictive ephemeris of a satellite for a predetermined period, and a communication unit that transmits the acquired predicted orbit data sequence to a relay satellite, wherein the data acquisition unit acquires a first data sequence that is the predicted orbit data sequence having a first data amount and a second data sequence that is the predicted orbit data sequence having a second data amount smaller than the first data amount, and the communication unit transmits the first data sequence or the second data sequence as orbit information of a satellite to a relay satellite, the first data sequence or the second data sequence selected in accordance with predetermined selection criteria.

### TECHNICAL FIELD

The present disclosure relates to an earth station, a relay satellite, a satellite system and a communication method.

### BACKGROUND ART

An earth station and a user satellite (for example, an observation satellite, a communication satellite, and so on) can communicate with each other via a relay satellite. In the communication between the earth station and the user satellite via the relay satellite, the user satellite and the relay satellite exchange data in inter-satellite communication.

For example, JP 2013-070226A discloses a satellite system for enabling satellite communication over all orbits through short-wave communication between earth stations and communication relay satellites traveling around lower orbits.

### CITATION LIST

### Patent Literature

[PTL 1]

JP 2013-070226A

### SUMMARY OF INVENTION

### Technical Problem

In the inter-satellite communication, utilization of inter-satellite optical communication where a user satellite and a relay satellite conduct the inter-satellite communication through optical communication is being discussed. In order to initiate the inter-satellite optical communication, a source communication satellite needs to predict position information of a target communication satellite with a high accuracy. For example, the source communication satellite may calculate the orbit of the target communication satellite based on Keplerian six orbit elements composed of a semi-major axis, an eccentricity, an orbit inclination, a longitude of ascending node, an argument of periapsis, and a mean anomaly for the target communication satellite. Typically, the source communication satellite may calculate orbit data for the target communication satellite based on the six orbit elements for the target communication satellite that are stored in advance or obtained from an earth station and determine the relative position to the target communication satellite and the attitude of the source communication satellite based on the calculated orbit data to control the orientation of an optical signal.

However, the satellites typically possess a limited calculation capability. Accordingly, for the relay satellites required to communicate with a large number of target communication satellites, a calculation load of calculating the orbit data for the target communication satellites may be excessive.

In light of the above-stated problem, one object of the present disclosure is to provide a technique for achieving the inter-satellite optical communication for a satellite having a limited calculation capability.

### Solution to Problem

One aspect of the present disclosure relates to an earth station, comprising: a data acquisition unit that acquires a predictied orbit data sequence indicative of a predictive ephemeris of a satellite for a predetermined period; and a communication unit that transmits the acquired predicted orbit data sequence to a relay satellite, wherein the data acquisition unit acquires a first data sequence that is the predicted orbit data sequence having a first data amount and a second data sequence that is the predicted orbit data sequence having a second data amount smaller than the first data amount, and the communication unit transmits the first data sequence or the second data sequence as orbit information of a satellite to a relay satellite, the first data sequence or the second data sequence selected in accordance with predetermined selection criteria.

### Advantageous Effects of Invention

According to the present disclosure, the technique for achieving the inter-satellite optical communication, which requires highly accurate orbit prediction, for a satellite having a limited calculation capability can be provided.

### BRIEF DESCRIPTION OF DRAWINGS

FIG. 1 is a schematic diagram for illustrating a satellite system according to one embodiment of the present disclosure;

FIG. 2 is a schematic diagram for illustrating a communication enabled area between an earth station and satellites according to one embodiment of the present disclosure;

FIG. 3 is a schematic diagram for illustrating communication between an earth station and a user satellite via a relay satellite according to one embodiment of the present disclosure;

FIG. 4 is a schematic diagram for illustrating a communication establishment procedure according to one embodiment of the present disclosure;

FIG. 5 is a block diagram for illustrating a hardware arrangement of an earth station according to one embodiment of the present disclosure;

FIG. 6 is a block diagram for illustrating a hardware arrangement of a user satellite and a relay satellite according to one embodiment of the present disclosure;

FIG. 7 is a block diagram for illustrating a functional arrangement of an earth station according to one embodiment of the present disclosure;

FIG. 8 is a diagram for illustrating a predicted orbit position sequence according to one embodiment of the present disclosure;

FIG. 9 is a diagram for illustrating a predicted orbit position sequence according to one embodiment of the present disclosure;

FIG. 10 is a diagram for illustrating a predicted orbit position sequence according to one embodiment of the present disclosure;

FIG. 11 is a diagram for illustrating a predicted orbit position sequence according to one embodiment of the present disclosure;

FIG. 12 is a block diagram for illustrating a functional arrangement of a relay satellite according to one embodiment of the present disclosure;

FIG. 13 is a sequence diagram for illustrating a communication operation according to one embodiment of the present disclosure;

FIG. 14A is a block diagram for illustrating a communication operation between an earth station and a relay satellite according to one embodiment of the present disclosure;

FIG. 14B is a block diagram for illustrating a communication operation between an earth station and a relay satellite according to one embodiment of the present disclosure; and

FIG. 14C is a block diagram for illustrating a communication operation between an earth station and a relay satellite according to one embodiment of the present disclosure.

### DESCRIPTION OF EMBODIMENTS

Embodiments of the present disclosure are described below with reference to the drawings.

In embodiments stated below, a satellite system including an earth station, a relay satellite and a user satellite is disclosed. Although the following embodiments are described in conjunction with inter-satellite optical communication between the relay satellite and the user satellite in the satellite system, the present disclosure is not necessarily limited to it and is applicable to the inter-satellite optical communication between two arbitrary satellites.

### Overview of the Present Disclosure

In embodiments below, an earth station calculates a data sequence (for example, predictive ephemeris data) indicative of a predictive ephemeris of a satellite and transmits the calculated data sequence to a relay satellite so as to reduce a calculation workload in the relay satellite. Here, the predictive ephemeris data sequence may be calculated not only based on Keplerian six orbit elements but also in consideration of perturbation factors such as a nonspherical component of the earth gravity, attractive forces of the sun and the moon, an atmospheric drag, a solar radiation pressure or an earth gravity distortion due to tides. Accordingly, orbit prediction can be achieved more accurately than the case where the satellite orbit is calculated within the relay satellite based on the Keplerian six orbit elements. In addition, the earth station may provide the relay satellite with the predictive ephemeris data sequence required to achieve satellite communication with a user satellite via the relay satellite with an appropriate granularity or resolution.

Conventionally, the relay satellite acquires or has six orbit elements (for example, according to the Keplerian six orbit elements, a semi-major axis, an eccentricity, an orbit inclination, a longitude of ascending node, an argument of periapsis, and a mean anomaly) for respective communication target user satellites and calculates orbit data for the respective user satellites based on these six orbit elements to facilitate inter-satellite optical communication with the respective user satellites. Accordingly, the relay satellite must calculate the orbit data pieces corresponding to the number of user satellites. If the relay satellite covers a large number of user satellites, a higher calculation capability must be provided to the relay satellite. Typically, even in cases where a general personal computer on the earth is used, it may take several tens of minutes to calculate an amount of the orbit data corresponding to one day for a single user satellite so as to obtain a calculation result with a sufficient accuracy. The orbit data, meanwhile, typically is calculated by means of an onboard computer having radiation resistance provided in the relay satellite. Accordingly, it is not easy to improve the calculation capability required to obtain the calculation result with a sufficient accuracy, which may increase the production cost and the operational risk of the relay satellite.

Also, according to the orbit calculation based on Keplerian six orbit elements, an accumulated calculation error may be greater for the satellite orbit at further time points, which may degrade the accuracy of orbit prediction of the satellite at the further time points. On the other hand, if the amount of data or calculation required to reduce the calculation error is increased, it may become difficult to process the data in the relay satellite. Also, according to the orbit calculation based on Keplerian six orbit elements, it is difficult to calculate the orbits by taking into account perturbation factors (deviation of motion of a planet, a small planet or the like from Kepler's laws) with a high accuracy. A nonspherical component of the earth gravity, attractive forces of the sun and the moon, an atmospheric drag, a solar radiation pressure, an earth gravity distortion due to tides and the like are known as main perturbation factors for satellites traveling around the earth.

In order to perform more directional optical communication between satellites, highly accurate orbit prediction is required for transmitting and receiving satellites. Namely, in order for two satellites having optical communication devices, which may be a relay satellite and a user satellite, to perform optical communication with use of laser beams between the two satellites, it is necessary to calculate the positions and velocities of its own satellite and a target satellite and direct respective optical telescopes to the target satellites each other. The current position of the satellite itself can be obtained from a GPS (Global Positioning System), and on the other hand, the positions of the satellite itself and the communication target satellite at a time instant in the future can be calculated based on predicted values of the satellite orbits. Also, since the optical communication device in the communication target user satellite must be also directed toward the position of the relay satellite, in addition of prediction (calculation) of the orbit of the communication target user satellite, it may be required to predict (calculate) the orbit (future position) of the relay satellite with a higher accuracy.

Calculation as to where and at what velocity an artificial satellite moving at a certain location and a certain velocity at a certain time instant may be moving at a subsequent time instant is referred to as “orbit propagation”. In cases of orbits of artificial satellites moving under the gravity of a single celestial body such as the earth, the orbit can be analytically calculated (in accordance with a simple formula), but more complicated numerical calculation may be required for the more complicated orbit propagation. As major orbit propagators, an analytic type of propagator, a quasi-analytic type of propagator, and a numerical integration type of propagator are known. The orbit propagation calculation models are divided into an analytic method and a numerical integration method. In the analytic method, a less amount of calculation may be required due to approximate calculation, but the error relative to the actual orbit of a satellite may be greater. On the other hand, in the numerical integration method, the accuracy may increase, but parameters and calculation amounts may also increase.

Two-Line Elements (TLE) are used as a data format indicative of Keplerian orbit element values representing the orbit of a satellite (particularly, an artificial satellite traveling at a low altitude) traveling around the earth. An earth station according to embodiments below generates a predictive ephemeris data sequence to improve the accuracy through various corrections to perturbation or the like, other than the case where Keplerian six orbit elements are used for calculation of a predicted ephemeris of a user satellite. The predictive ephemeris data sequence for a satellite may be calculated in accordance with (1) a calculation method based on TLE as well as (2) a calculation method based on GPS positioning information for the satellite transmitted from the satellite in downlinks. The predictive ephemeris data may be composed of time series data of orbit elements: an epoch (reference time), a position (X, Y, Z), a velocity (X_DOT, Y_DOT, Z_DOT) and an (optional) acceleration (X_DDOT, Y_DDOT, Z_DDOT).

In the embodiments of the present disclosure, the predictive ephemeris data sequence for a user satellite may be calculated on the earth, instead of on a relay satellite, by correcting influences from the perturbation in addition to using the Keplerian six orbit elements. The earth station transmits the predictive ephemeris data sequence calculated with a high accuracy to the relay satellite. An OEM (Orbit Ephemeris Message) for a CCSDS (Consultative Committee for Space Data System) 502.0-B-2 ODM (Orbit Data Message) may be used for the predictive ephemeris data sequence transmitted in uplinks. The relay satellite may conduct inter-satellite optical communication with a user satellite based on the prediction ephemeris data sequence obtained from the earth station. Further, position data sequences with different temporal resolutions are calculated on the earth, and the earth station may transmit the prediction ephemeris data sequence with a temporal resolution, which is properly selected in accordance with predetermined selection criteria, to the relay satellite.

For example, the predetermined selection criteria may be relevant with the distance between a user satellite and a relay satellite, the communication state between an earth station and a relay satellite, the capability of a relay satellite, a remaining computing power of a relay satellite or the like. For example, if the communication state between an earth station and a relay satellite is good, it is envisaged that a relatively large amount of data can be transmitted from the earth station to the relay satellite. Accordingly, the earth station may transmit a position data sequence having a relatively high temporal resolution to the relay satellite. On the other hand, if the communication state between the earth station and the relay satellite is not so good, it is envisaged that a relatively small amount of data can be transmitted from the earth station to the relay satellite. Accordingly, the earth station may transmit a position data sequence having a relatively low temporal resolution to the relay satellite.

The relay satellite can use the predictive ephemeris data sequence for the user satellite selected in this manner to achieve good inter-satellite optical communication with the user satellite. Note that although the predictive ephemeris data sequence for the user satellite is focused on in embodiment below, the data transmitted from the earth station to the relay satellite according to the present disclosure is not limited to it, and any other type of data may be used to fulfill the inter-satellite optical communication.

### Satellite System

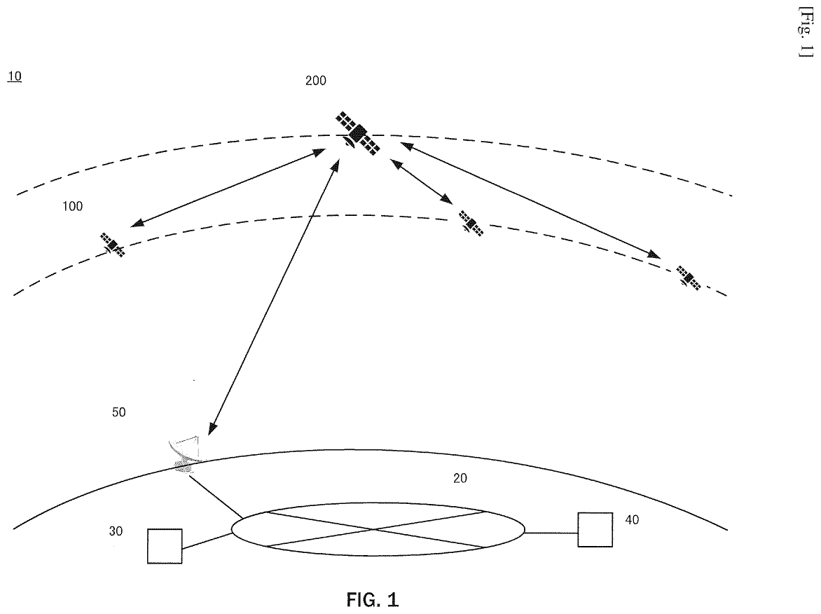

As illustrated in FIG. 1, a satellite system 10 includes an earth station 50, user satellites 100 and a relay satellite 200. The user satellites 100 and the relay satellite 200 travel along different orbits around the earth, for example. For example, if the user satellites 100 are observation satellites, the multiple user satellites 100 may travel around the earth in a predetermined constellation (satellite constellation) so that the multiple user satellites 100 can be used to observe an observation targeted area on the earth.

The user satellite 100 may be, but not limited to it, an artificial satellite having predetermined functionalities that travels on an orbit of a predetermined altitude around the earth such as an observation satellite or a communication satellite.

The relay satellite 200 may, but not limited to it, serve as a relay station that travels around the earth on an orbit of a higher altitude than the user satellites 100 for data transmission and reception between the earth station 50 on the earth and the user satellites 100. Typically, the relay satellite 200 may cover the plurality of user satellites 100 and communicate with a desired user satellite 100.

The earth station 50 is a communication station that communicates with the relay satellite 200. The earth station 50 can communicate with the user satellites 100 via the relay satellite 200. Also, if the earth station 50 can communication with the user satellites 100 without via the relay satellite 200, the earth station 50 may communicate with the user satellites directly. In the illustrated example, the earth station 50 is provided on the ground, but the earth station 50 according to the present disclosure may be, but not limited to it, a communication station in a non-terrestrial network (NTN) configured in the stratosphere and so on, for example. For example, the earth station 50 may be communicatively connected to a relay satellite operator 30 and a user satellite operator 40 via a network 20 such as the Internet. Information obtained from the user satellite 100 via the relay satellite 200 is delivered to the relay satellite operator 30 and/or the user satellite operator 20 via the Internet.

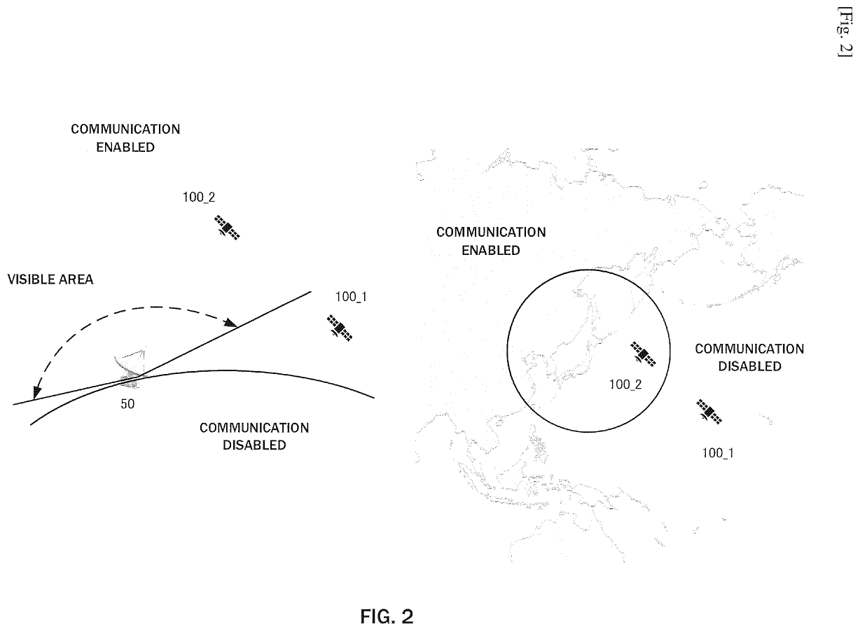

As illustrated in FIG. 2, a communication coverage area of the earth station 50 with user satellites is determined by a visible range of the earth station 50. In the illustrated example, the earth station 50 can communicate with the user satellite 100_2 located in a communication enabled area whereas the earth station 50 cannot communicate with the user satellite 100_1 located in a communication disabled area.

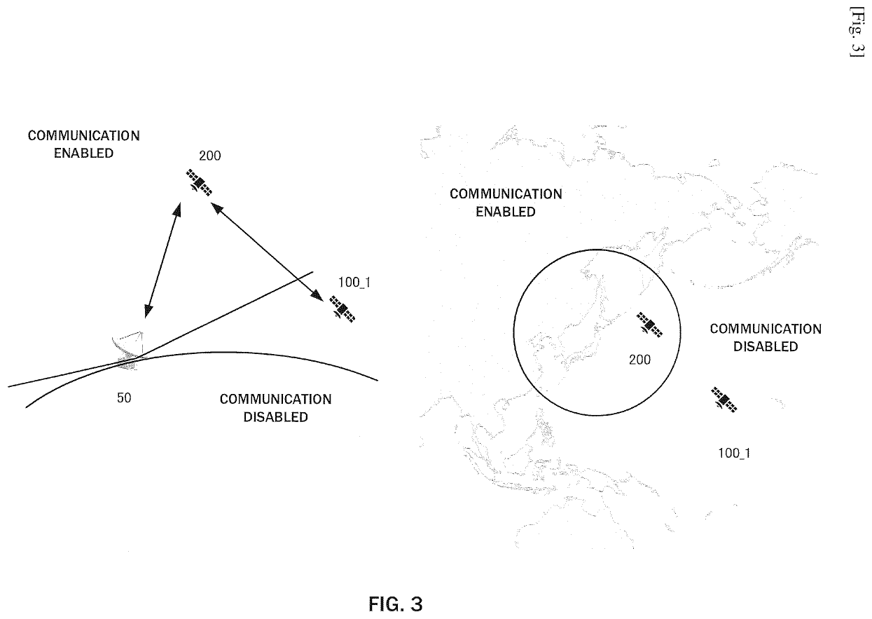

In this case, as illustrated in FIG. 3, the earth station 50 can use the relay station 200 located in the communication enabled area to communicate with the user satellite 100_1 located in the communication disabled area via the relay satellite 200.

According to the inter-satellite optical communication in the satellite system 10, the relay satellite 200 first transmits an optical beacon on a traveling orbit of a user satellite 100 based on a position data sequence of the user satellite 100. For example, the optical beacon may be a pulse-formatted optical signal having an identifier of the relay satellite 200 and an identifier of the communication opponent user satellite 100 encoded. Upon determining that the user satellite 100 is being requested by the relay satellite 200 as the communication opponent, the user satellite 100 may establish a communication connection to the relay satellite 200 transmitting the optical beacon and initiate communication with the relay satellite 200.

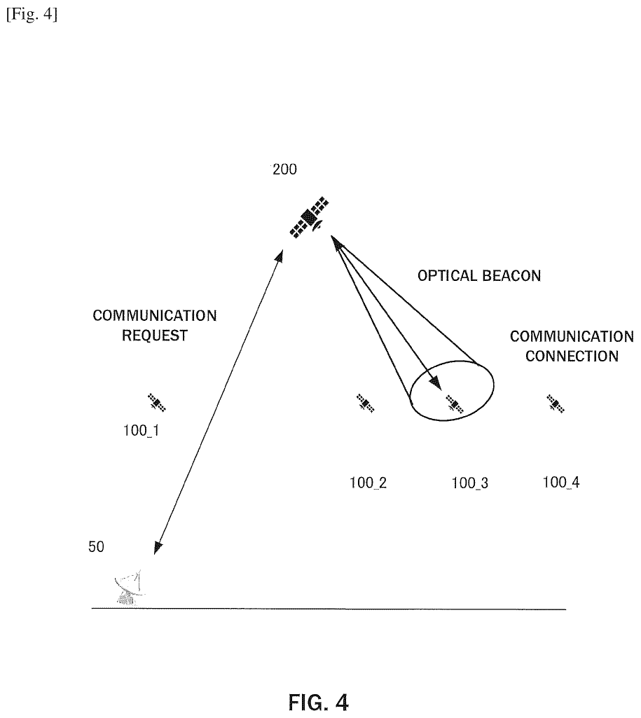

For example, as illustrated in FIG. 4, in order to initiate the inter-satellite optical communication with the user satellite 100_3, the relay satellite 200 may transmit an optical beacon for detecting the user satellite 100_3 to the orbit of the user satellite 100_3. For example, the optical beacon may be transmitted toward the location of the user satellite 100_3 predicted from the position data sequence for the user satellite 100_3 stored in the relay satellite 200 and be composed of less directional light to cover a wide area including the predicted position. For example, the optical beacon may be composed as a pulse signal into which the identifier of the relay satellite 200 and the identifier of the user satellite 100_3 requested as the communication opponent are encoded.

Upon detecting the optical beacon transmitted from the relay satellite 200, the user satellite 100_3 retrieves the identifier of the relay satellite 200 and the identifier of the requested communication opponent encoded into the optical beacon. The user satellite 100_3 determines whether the retrieved identifier of the communication target matches its own identifier. In this example, since the identifier of the user satellite 100_3 is included in the optical beacon, the user satellite 100_3 determines that it is requested as the communication target and proceeds to a communication establishment procedure with the relay satellite 200. When a communication connection has been established between the user satellite 100_3 and the relay satellite 200 in accordance with the predetermined communication establishment procedure, the user satellite 100_3 and the relay satellite 200 transmit and receive data each other through more directional communication light. In this manner, the earth station 50 can communicate with the user satellite 100_3 via the relay satellite 200.

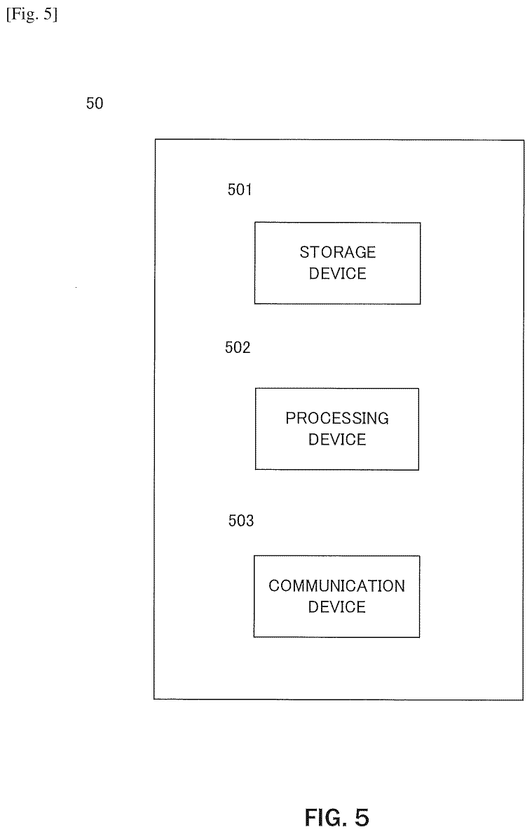

Here, the earth station 50 may have a hardware architecture as illustrated in FIG. 5, for example. As illustrated in FIG. 5, the earth station 50 has a storage device 501, a processing device 502 and a communication device 503.

The storage device 501 stores various data and programs for the inter-satellite optical communication between the user satellite 100 and the earth station 50 via the relay satellite 200. For example, the data and the programs may be stored in advance, be obtained via the network 20, or be input from an operator of the earth station 50. For example, the storage device 501 may be implemented with a non-transitory storage medium such as a memory, a storage or the like.

The processing device 502 executes programs loaded from the storage device to control components in the earth station 50 and perform various operations for the inter-satellite optical communication. For example, the processing device 502 may be implemented with a processor, a signal processing circuitry or the like.

The communication device 503 is controlled by the processing device 502 to transmit and receive data. For example, the communication device 503 may be implemented with a communication interface, a communication circuitry, an antenna, or the like, for example. For example, the communication device 503 may transmit and receive data via the network 20 or to and from the user satellites 100 and/or the relay satellite 200 via an antenna.

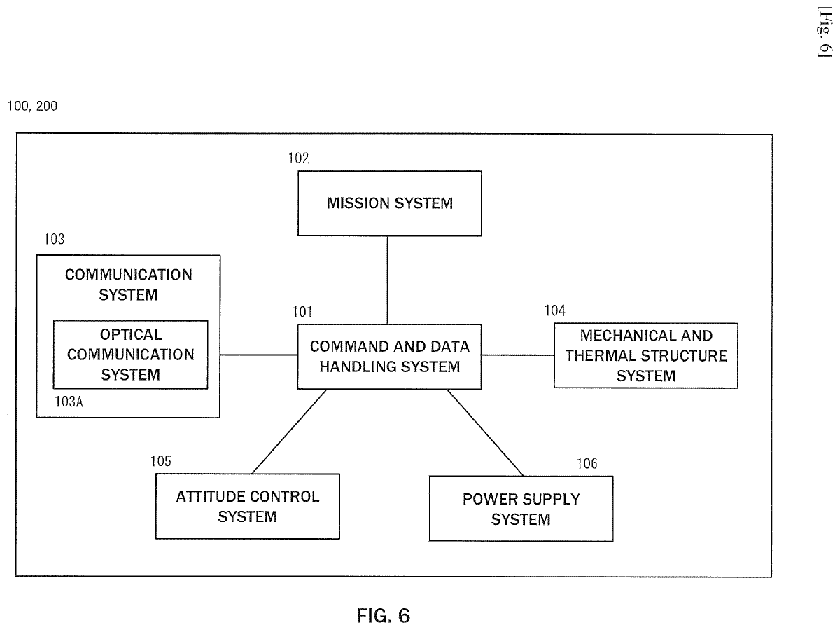

Next, the user satellite 100 may have a hardware architecture as illustrated in FIG. 6, for example. Specifically, each of the user satellite 100 and the relay satellite 200 has a command and data handling system 101, a mission system 102, a communication system 103, a mechanical and thermal structure system 104, an attitude control system 105 and a power supply system 106.

The command and data handling system 101 processes received commands as well as status data, mission data or the like for the satellite. For example, the command and data handling system 101 has a processing circuit for data processing and uses the processing circuit to operate as various functional units as stated below.

The mission system 102 implements functionalities (missions) specific to the respective satellite. For example, if the satellite is an earth observation satellite, the mission system 102 may be composed of various kinds of sensors, such as an image sensor, a data processer or the like. Also, if the satellite is a communication satellite, the mission system 102 may be composed of an antenna and/or a communication device for relaying data.

The communication system 103 may be composed of an antenna and/or a communication device for receiving commands from the earth station 50 and transmitting telemetry data such as states of the satellite, data observed by the satellite, or the like to the earth station 50. Also, the communication system 103 has an optical communication system 103A for communicating with the relay satellite 200 through inter-satellite optical communication. The optical communication system 103A has a camera for capturing surroundings of the user satellite 100 to capture a non-terrestrial area such as outer space and receive optical beacons and communication light for the inter-satellite optical communication. For example, the camera may always capture the non-terrestrial area of the surrounding of the satellite at a predetermined frame rate (for example, 30 fps) and deliver the captured image frames of the non-terrestrial area to the command and data handling system 101 or the like. Also, the camera may include an omnidirectional lens such as a circumferential fish-eye lens so that a wider area can be captured.

The mechanical and thermal structure system 104 may be composed of a satellite body, movable extensions such as a solar battery panel and a mechanism for stabilizing the inner temperature of the satellite and releasing the heat of the satellite.

The attitude control system 105 may be composed of a sensor for measuring the position and/or the attitude of the satellite, a thruster for changing the altitude and/or the attitude of the satellite or the like to control the position and/or the attitude of the satellite on the orbit.

The power supply system 106 may control and manage power consumed in the satellite. For example, the power supply system 106 may charge the power generated at a solar battery panel to a battery and/or supply the required power to the respective systems in the satellite.

The relay satellite 200 can a hardware arrangement as illustrated in FIG. 6. However, the above-stated hardware arrangement is merely one example, and the earth station 50, the user satellite 100 and the relay satellite 200 according to the present disclosure may be implemented with any other appropriate hardware architectures. Also, the above-stated grouping into the respective systems is merely one example, and the hardware architecture of the earth station 50, the user satellite 100 and the relay satellite 200 may be described according to other groupings. For example, a certain equipment and mechanism may be grouped or classified into different systems depending on the mission of the satellite. For example, since the relay satellite 200 is mainly intended to relay data with optical communication as its main mission, an optical communication device 103A (for example, a camera, an optical telescope, an optical transmitter and so on) may be classified into the mission system 102. On the other hand, if the user satellite 100 is mainly intended to observe the earth as its main mission, the optical communication device (for example, a camera, an optical telescope, an optical transmitter and so on) for communication with the relay satellite 200 may be classified into the communication system 103.

### Earth Station

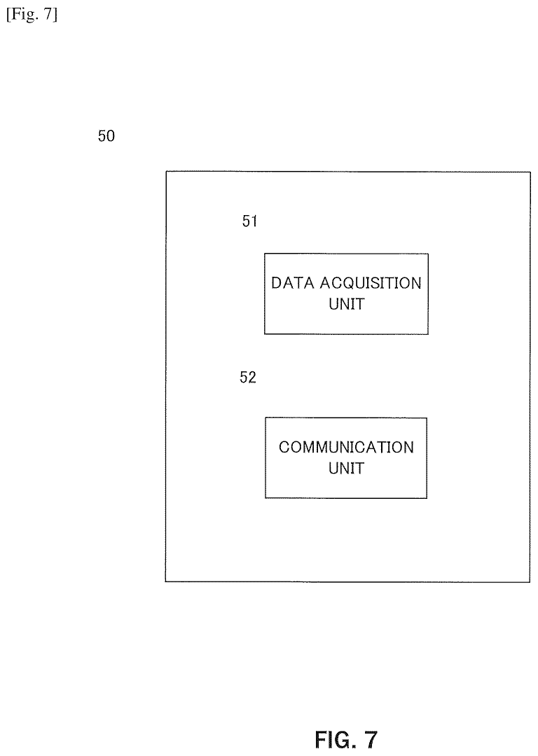

Next, the earth station 50 according to one embodiment of the present disclosure is described with reference to FIG. 7. FIG. 7 is a block diagram for illustrating a functional configuration of the earth station 50 according to one embodiment of the present disclosure.

As illustrated in FIG. 7, the earth station 50 has a data acquisition unit 51 and a communication unit 52. These functional units may be implemented with any or combinations of the above-stated hardware device.

The data acquisition unit 51 acquires a data sequence indicative of a predicted ephemeris of a satellite. For example, the data sequence may be predictive ephemeris data of the user satellite 100 and/or the relay satellite 200. The data acquisition unit 51 may calculate the predictive ephemeris data in accordance with any of (1) a calculation method based on TLE and (2) a calculation method based on GPS positioning information transmitted from satellites in downlinks. Specifically, the predictive ephemeris data sequence may be composed of time-series data of the positions and velocities of the satellite at respective time points. Alternatively, the predictive ephemeris data sequence may be composed of time-series data of the positions, velocities and accelerations of the satellite at respective time points.

The data sequence may be calculated by taking into account perturbation factors. As specific examples of the perturbation factors, main perturbation factors of a satellite traveling around the earth may be a non-spherical component of the earth gravity, the gravitational pull of the sun and the moon, an atmospheric drag, a solar radiation pressure, a tidal distortion of the earth gravity and so on. The data acquisition unit 51 may use an analytic method or a numerical integration method to calculate the predictive ephemeris data sequence by taking into account perturbation factors.

In one embodiment, the data acquisition unit 51 may acquire a first data sequence having a first temporal resolution and a second data sequence having a second temporal resolution lower than the first temporal resolution. These data sequences may be the predictive ephemeris data sequences for the user satellite 100 and/or the relay satellite 200. Specifically, the first data sequence and the second data sequence may be composed of vector data having the same dimension or size such as the predictive ephemeris data sequences. In this case, the first data sequence may be a data sequence composed of M pieces of data, and the second data sequence may be a data sequence composed of N (M>N) pieces of data.

In one embodiment, the first data sequence may be a first predictive ephemeris data sequence (for example, a predictive ephemeris data sequence with a high temporal resolution) having a first temporal resolution for the user satellite 100, and the second data sequence may be a second predictive ephemeris data sequence (for example, a predictive ephemeris data sequence with a low temporal resolution) having a second temporal resolution lower than the first temporal resolution for the user satellite 100. For example, the first prediction ephemeris data sequence may be time-series data of 60 pieces of position data indicative of the position of the user satellite 100 every one minute in a certain period of time having one hour in time length, and the second prediction ephemeris data sequence may be time-series data of 6 pieces of position data indicative of the position of the user satellite 100 every ten minutes in the period of time. Here, the position of the user satellite 100 may be represented in any appropriate method publicly known in this technical field, for example, the position on predetermined coordinate axes, the relative position to the relay satellite 200, or the like. However, the data sequence according to the present disclosure may not be necessarily limited to the predictive ephemeris data sequence and be any other appropriate type of time-series data that can indicate the orbit of the user satellite 100 such as a direction data sequence indicative of the direction of the user satellite 100 relative to the relay satellite 200.

For example, the relay satellite 200 can predict the position of the user satellite 100 at any time point in the period of time through interpolation of the predictive ephemeris data sequence composed of such discrete time-series data. Then, it may be considered that the orbit of the user satellite 100 acquired through interpolation of a first predictive ephemeris data sequence (for example, a prediction ephemeris data sequence with a high temporal resolution) with a higher temporal resolution may have a higher accuracy than the orbit of the user satellite 100 acquired through interpolation of a second predictive ephemeris data sequence (for example, a prediction ephemeris data sequence with a low temporal resolution) with a lower temporal resolution. On the other hand, it may be considered that a computational load required for the interpolation of the first predictive ephemeris data sequence may be smaller than a computational load required for the interpolation of the second prediction ephemeris data sequence. Also, if the predictive ephemeris data sequence for a predetermined time period is transmitted from the earth station 50 to the relay satellite 200, the data amount for transmitting the first prediction ephemeris data sequence from the earth station 50 to the relay satellite 200 may be larger than the data amount for transmitting the second prediction ephemeris data sequence, which may cause a longer communication time.

The communication unit 52 transmits the acquired data sequence to the relay satellite 200. Specifically, the communication unit 52 transmits the predictive ephemeris data sequence to the user satellite 100 and/or the relay satellite 200. Conventionally, the transmission data rate from the earth station 50 to the user satellite 100 and/or the relay satellite 200 may be about several kbps to several hundreds kbps, but it is envisaged that a higher transmission data rate than several Mbps can be achieved in future. For the predictive ephemeris data sequence transmitted from the earth station 50 to the user satellite 100 and/or the relay satellite 200, four types below may be considered.
Type I: The communication unit 52 may transmit the predictive ephemeris data sequence for the relay satellite 200 to the relay satellite 200. The relay satellite 200 can use the predictive ephemeris data sequence to predict its own orbit with a higher accuracy. Note that the relay satellite 200 may calculate the position and velocity of the relay satellite 200 based on the GPS positioning information.
Type II: The communication unit 52 may transmit the predictive ephemeris data sequence for the user satellite 100 to the relay satellite 200. The relay satellite 200 can use the predictive ephemeris data sequence to predict the orbit of the user satellite 100 with a higher accuracy.
Type III: The communication unit 52 may transmit the predictive ephemeris data sequence for the relay satellite 200 to the user satellite 100. The user satellite 100 can use the predictive ephemeris data sequence to predict the orbit of the relay satellite 200 with a higher accuracy.
Type IV: The communication unit 52 may transmit the prediction ephemeris data sequence for the user satellite 100 to the user satellite 100. The user satellite 100 can use the prediction ephemeris data sequence to predict its own orbit with a higher accuracy. Note that the user satellite 100 may calculate the position and velocity of the user satellite 100 based on the GPS positioning information.

The communication unit 52 may transmit a data sequence selected from a first data sequence and a second data sequence in accordance with predetermined selection criteria as orbit information for the user satellite 100 to the relay satellite 200. For example, the communication unit 52 may select one of the first data sequence and the second data sequence in accordance with the predetermined selection criteria and transmit the selected data sequence to the relay satellite 200. Alternatively, the communication unit 52 may receive a selection instruction based on the predetermined selection criteria via the network 20 or the like and transmit the data sequence selected from the first data sequence and the second data sequence based on the selection instruction. Namely, the communication unit 52 may switch between the first data sequence and the second data sequence in accordance with the predetermined selection criteria.

For example, the communication unit 52 may switch between transmission of the first data sequence and transmission of the second data sequence depending on the size of an acceptable range of prediction errors for the position of the user satellite 100 from a viewpoint of the relay satellite 200. Specifically, if the acceptable range of prediction errors is larger than or equal to a predetermined threshold, the communication unit 52 may transmit the second data sequence (for example, the predictive ephemeris data sequence with a low temporal resolution) to the relay satellite 200. On the other hand, if the acceptable range of prediction errors is smaller than the predetermined threshold, the communication unit 52 may transmit the first data sequence (for example, the prediction ephemeris data sequence with a high temporal resolution) to the relay satellite 200.

In one embodiment, the predetermined selection criteria may be associated with the distance between the user satellite 100 and the relay satellite 200. If the distance is smaller than a predetermined distance threshold, the communication unit 52 may transmit the first data sequence as orbit information to the relay satellite 200, and if the distance is larger than or equal to the predetermined distance threshold, the communication unit 52 may transmit the second data sequence as the orbit information to the relay satellite 200. Namely, the communication unit 52 may switch the data sequence based on the distance between the user satellite 100 and the relay satellite 200 for transmission to the relay satellite 200.

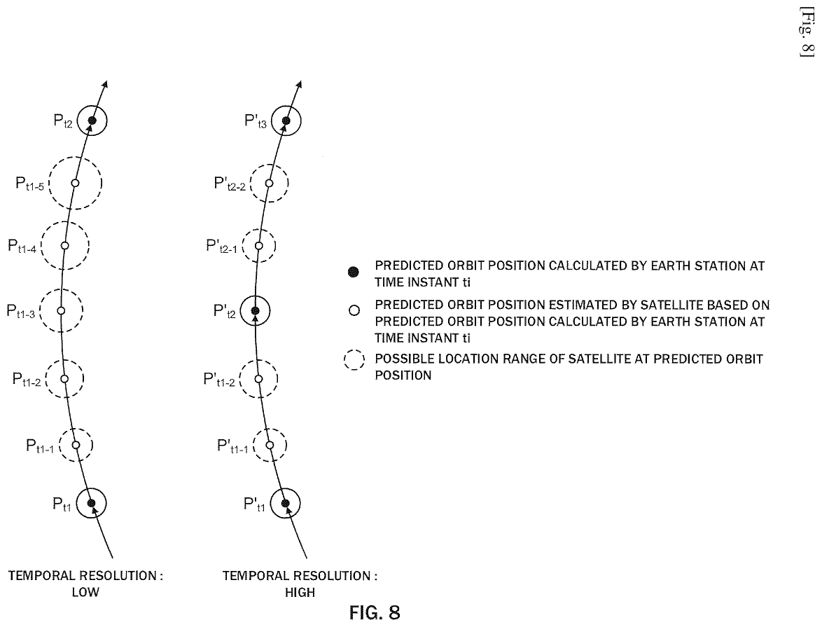

For example, in the example as illustrated in FIG. 8, two curves indicate a predictive ephemeris data sequence with a low temporal resolution and a predictive ephemeris data sequence with a high temporal resolution obtained in highly accurate orbit prediction. The circles “●” indicate positions of the user satellite 100 based on the predictive ephemeris data, and the circles “◯” indicate estimated positions of the user satellite 100 obtained through interpolation based on the predictive ephemeris data sequence obtained from the earth station 50. Also, the dashed circles indicate the range of prediction errors of the estimated positions. The prediction errors of estimated positions may become greater, as the amount of lapsed time from the positions of the circles “●” becomes greater. For example, the prediction error at the time instant Pₜ₁₋₅ would be greater than that at the time instant Pₜ₁₋₁. As be understood in FIG. 8, the estimated position of the user satellite 100 obtained through interpolation based on the prediction ephemeris data sequence with a high temporal resolution can be limited to a prediction error range (a possible existence range of the user satellite 100) having a smaller radius.

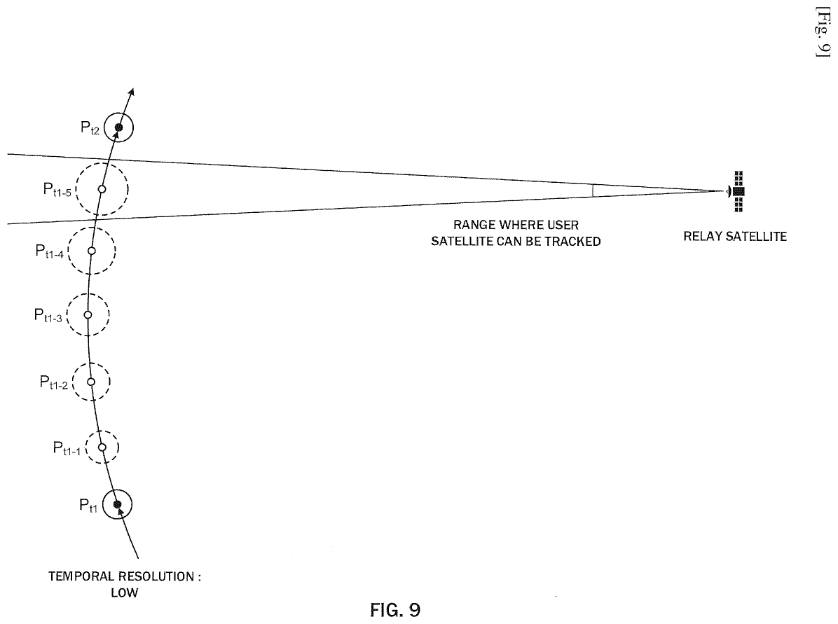

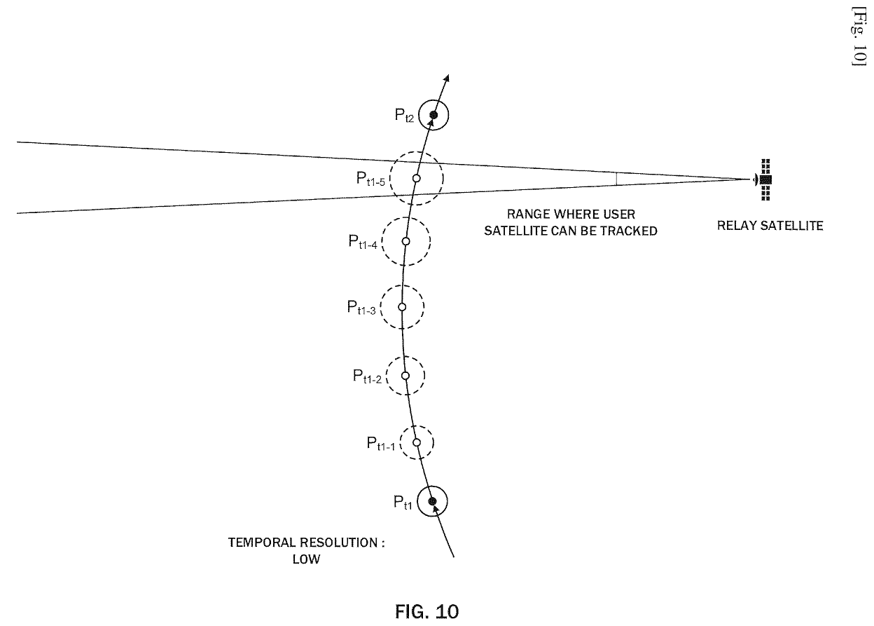

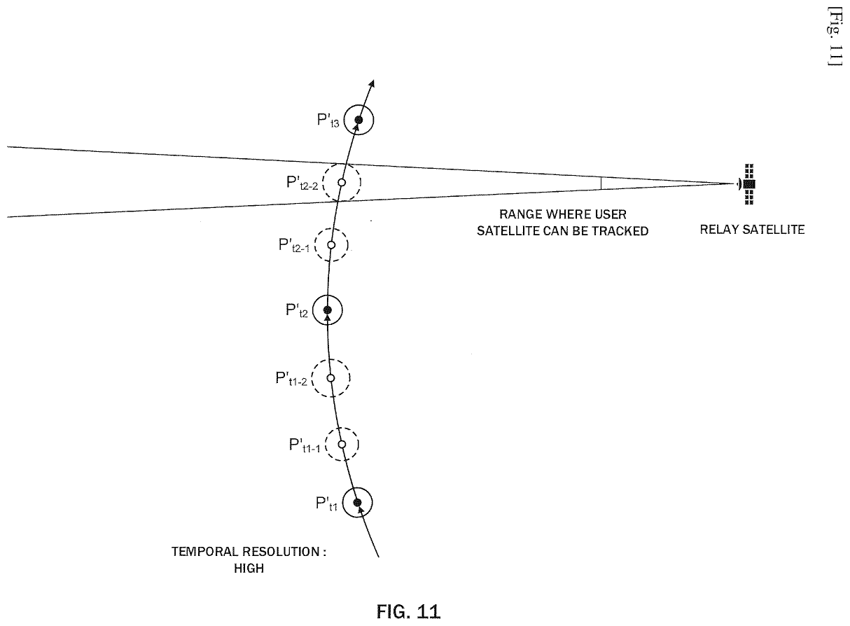

In FIG. 9, the two lines extending from the relay satellite 200 indicate a possible tracking range of the user satellite 100. When the distance between the user satellite 100 and the relay satellite 200 is large, the possible existence range of the user satellite 100 may be within the possible tracking range even according to the predictive ephemeris data sequence with a low temporal resolution. On the other hand, if the distance between the user satellite 100 and the relay satellite 200 is small, the possible existence range of the user satellite 100 could be out of the possible tracking range according to the predictive ephemeris data sequence with a low temporal resolution, and thus the relay satellite 200 may not be able to track the user satellite 100, as illustrated in FIG. 10. In this case, as illustrated in FIG. 11, the predictive ephemeris data sequence with a high temporal resolution can be used to make the possible existence range of the user satellite 100 smaller, and the position prediction error of the user satellite 100 could be accordingly within the possible tracking range.

According to this embodiment, the data sequences for transmission to the relay satellite 200 can be properly switched based on the distance between the user satellite 100 and the relay satellite 200.

Also in one embodiment, the predetermined selection criteria may be associated with the communication state between the earth station 50 and the relay satellite 200. If the communication state is smaller than a predetermined quality threshold, the communication unit 52 may transmit the second data sequence as the orbit information to the relay satellite 200, and if the communication state is greater than or equal to the predetermined quality threshold, the communication unit 52 may transmit the first data sequence as the orbit information to the relay satellite 200. Namely, the communication unit 52 may switch between the data sequences for transmission to the relay satellite 200 based on the communication state between the earth station 50 and the relay satellite 200.

Specifically, if the communication state between the earth station 50 and the relay satellite 200 is not good, there is a likelihood that a larger amount of data sequence cannot be successfully transmitted to the relay satellite 200. Accordingly, the communication unit 52 may transmit the second data sequence, which is the predictive ephemeris data sequence with a lower temporal resolution, to the relay satellite 200 (for example, using iterative transmissions) to deliver the data sequence to the relay satellite 200 more reliably. On the other hand, if the communication state between the earth station 50 and the relay satellite 200 is good, it can be expected that a larger amount of data sequence can be successfully transmitted to the relay satellite 200. Accordingly, the communication unit 52 may transmit the first data sequence, which is the predictive ephemeris data sequence with a higher temporal resolution, to the relay satellite 200 to cause the relay satellite 200 to perform interpolation based on the first data sequence for estimation of the orbit of the user satellite 100 with a high accuracy.

According to this embodiment, the data sequences for transmission to the relay satellite 200 can be properly switched based on the communication state between the earth station 50 and the relay satellite 200.

Also in one embodiment, the predetermined selection criteria may be associated with the capability of the relay satellite 200. If the capability is lower than a predetermined capability level threshold, the communication unit 52 may transmit the second data sequence as the orbit information to the relay satellite 200, and if the capability is higher than or equal to the predetermined capability level threshold, the communication unit 52 may transmit the first data sequence as the orbit information to the relay satellite 200. Here, the capability of the relay satellite 200 may include a calculation capability, a storage capacity, a communication capability with the earth station 50, a capability of the optical communication system 103A for communicating with the user satellite 100 or the like, for example. Namely, the communication unit 52 may switch between the data sequences for transmission to the relay satellite 200 based on the capability of the relay satellite 200.

Specifically, if the capability of the relay satellite 200 is relatively low, there is a likelihood that the relay satellite 200 may not be able to process or utilize the predictive ephemeris data sequence with a low temporal resolution. Accordingly, the communication unit 52 may transmit the first data sequence with a higher temporal resolution to the relay satellite 200 to cause the relay satellite 200 to estimate the orbit of the user satellite 100 based on the first data sequence without use of the relatively high capability. On the other hand, if the capability of the relay satellite 200 is relatively high, there is a likelihood that the relay satellite 200 may be able to process or utilize the prediction ephemeris data sequence with a lower temporal resolution. Accordingly, the communication unit 52 may transmit the second data sequence with a lower temporal resolution to the relay satellite 200 to cause the relay satellite 200 to estimate the orbit of the user satellite 100 based on the second data sequence with a high accuracy by utilizing the relatively high capability.

According to this embodiment, the data sequences for transmission to the relay satellite 200 can be properly switched based on the capability of the relay satellite 200.

Also in one embodiment, the predetermined selection criteria may be associated with a remaining computing power of the relay satellite 200. If the remaining computing power is smaller than a predetermined threshold, the communication unit 52 may transmit the second data sequence as the orbit information to the relay satellite 200, and if the remaining computing power is greater than or equal to the predetermined threshold, the communication unit 52 may transmit the first data sequence as the orbit information to the relay satellite 200. Namely, the communication unit 52 may switch between the data sequences for transmission to the relay satellite 200 based on the remaining computing power of the relay satellite 200.

Specifically, if the remaining computing power of the relay satellite 200 is relatively low, there is a likelihood that the relay satellite 200 may not be able to perform interpolation based on the predictive ephemeris data sequence with a low temporal resolution. Accordingly, the communication unit 52 may transmit the first data sequence with a higher temporal resolution to the relay satellite 200 to cause the relay satellite 200 so that the relay satellite 200 can estimate the orbit of the user satellite 100 based on the first data sequence without necessity of a higher calculation load. On the other hand, if the remaining computing power of the relay satellite 200 is relatively high, it can be considered that the relay satellite 200 can process the predictive ephemeris data sequence with a low temporal resolution. Accordingly, the communication unit 52 may transmit the second data sequence with a lower temporal resolution to cause the relay satellite 200 so that the relay satellite 200 can estimate the orbit of the user satellite 200 based on the second data sequence with a high accuracy with use of the relatively high remaining computing power.

According to this embodiment, the data sequences for transmission to the relay satellite 200 can be properly switched based on the remaining computing power of the relay satellite 200.

### Relay Satellite

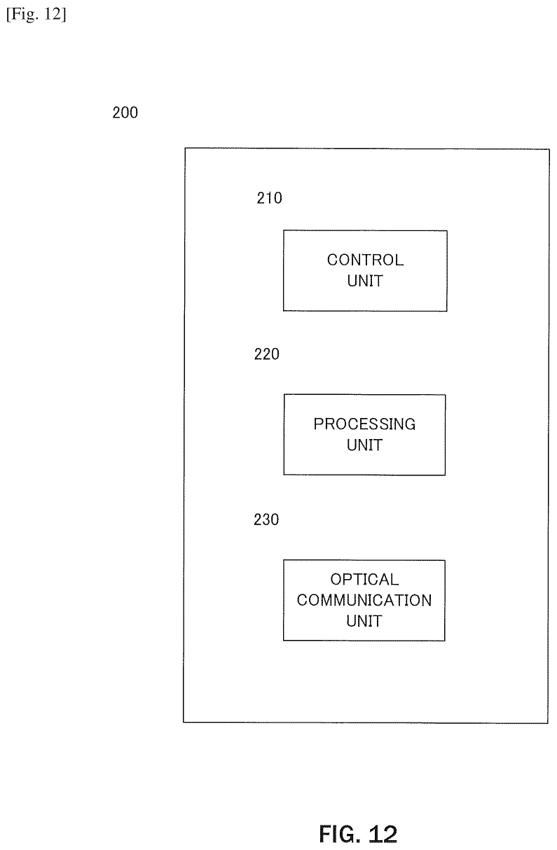

Next, the relay satellite 200 according to one embodiment of the present disclosure is described with reference to FIG. 12. FIG. 12 is a block diagram for illustrating a functional configuration of the relay satellite 200 according to one embodiment of the present disclosure.

As illustrated in FIG. 12, the relay satellite 200 has a control unit 210, a processing unit 220 and an optical communication unit 230. These functional units may be implemented in any or combinations hardware devices as stated above.

The control unit 210 acquires a data sequence indicative of a predicted ephemeris of a satellite. For example, the data sequence may be predictive ephemeris data for the user satellite 100 and/or the relay satellite 200. Specifically, the predictive ephemeris data may be composed of time-series data of the position and velocity of the satellite at respective time points. Alternatively, the predictive ephemeris data may be composed of time-series data of the position, velocity and acceleration of a satellite at respective time points.

The prediction ephemeris data sequence may be calculated by taking into account a perturbation factor. For example, the predictive ephemeris data sequence may be calculated by the earth station 50 by taking into account the perturbation factor using an analytic method or a numerical integration method. As examples of main perturbation factors for a satellite traveling around the earth, the perturbation factors may include a non-spherical component of the earth gravity, the gravitational pull of the sun and the moon, an atmospheric drag, a solar radiation pressure, an earth gravity distortion due to tides, and so on. In this manner, the control unit 210 can achieve more accurate orbit prediction with a smaller amount of calculation resources than conventional approaches where the relay satellite 200 receives Keplerian six orbit elements from the earth station 50 and calculates the predictive ephemeris data for the user satellite 100 based on the received six orbit elements without consideration of the perturbation factors.

The processing unit 220 performs interpolation on a predicted orbit for the user satellite 100 based on the acquired predictive ephemeris data sequence. The processing unit 220 acquires the position and velocity of the relay satellite 200 from a GPS measurement result and derives an attitude angle and an angular velocity as attitude data for the relay satellite 200 from an attitude sensor. Then, the processing unit 220 calculates the distance and direction of the user satellite 100 relative to the relay satellite 200 based on a positional relationship between the communication target user satellite 100 on a predicted orbit and the relay satellite 200. The acquisition and calculation of the predictive ephemeris data may be activated every N seconds (for example, every one second), for example, and may be performed depending on a temporal resolution of the acquired predictive ephemeris data sequence. The processing unit 220 may calculate the turning angle to orient an optical telescope in an optical communication device to the user satellite 100 (for example, turnable in two axes) based on the direction of the user satellite 100 and the attitude angle of the relay satellite 200.

The optical communication unit 230 performs inter-satellite optical communication with the user satellite 100 based on a predicted orbit through the interpolation. The optical communication unit 230 turns the optical telescope by the calculated turning angle to transmit and receive laser light. Here, the optical communication unit 230 may control the orientation of the optical communication device every a predetermined time period, for example, every 0.1 second. Accordingly, the prediction orbit may be interpolated every M seconds (M≤0.1) through interpolation using the predictive ephemeris data sequence based on the velocities and angular velocities of the user satellite 100 and the relay satellite 200. The distance between the user satellite 100 and the relay satellite 200 may be used for correction of an incoming light direction and an outgoing light direction in consideration of arrival time of laser light. For example, assuming that the distance between the user satellite 100 and the relay satellite 200 is L km, the light arriving from the user satellite 100 has been supposedly emitted before (L/3×10⁵) seconds. The optical communication unit 230 must emit the laser light in consideration of the traveling amounts of the user satellite 100 and the relay satellite 200 for that time period so that the laser light can arrive at the user satellite 100 after (L/3×10⁵) seconds.

In one embodiment, the control unit 210 acquires a data sequence selected from a first data sequence and a second data sequence in accordance with predetermined selection criteria. Here, the first data sequence has a first temporal resolution, and the second data sequence has a second temporal resolution lower than the first data sequence. Specifically, the first data sequence and the second data sequence may be composed of vector data having the same dimensions such as time-series data of predictive ephemeris data indicative of the orbit of the user satellite 100. In cases of the time-series data of predictive ephemeris data for the user satellite 100 for a predetermined time period, the first data sequence may be a data sequence composed of M pieces of data, and the second data sequence may be a data sequence composed of N (M>N) pieces of data.

In one embodiment, the first data sequence may be a first predictive ephemeris data sequence with a first temporal resolution (for example, a prediction ephemeris data sequence with a high temporal resolution) for the user satellite 100, and the second data sequence may be a second predictive ephemeris data sequence with a lower temporal resolution (for example, a prediction ephemeris data sequence with a low temporal resolution) than the first temporal resolution for the user satellite 100. For example, the first prediction ephemeris data sequence may be time-series data composed of 60 pieces of position data indicative of predicted positions of the user satellite 100 every one minute for a certain time period having one hour in time length, and the second predictive ephemeris data sequence may be time-series data composed of six pieces of position data indicative of predicted positions of the user satellite 100 ever ten minutes for the same time period. Here, the position of the user satellite 100 may be represented in any appropriate method publicly known in this technical field such as the position on a predetermined coordinate system, a relative position to the relay satellite 200. However, the data sequence according to the present disclosure may not be necessarily limited to the predictive ephemeris data sequence and may be any other appropriate type of time-series data indicative of the orbit of the user satellite 100 such as a direction data sequence indicative of the direction of the user satellite 100 relative to the relay satellite 200.

In one embodiment, the predetermined selection criteria may be associated with the distance between the user satellite 100 and the relay satellite 200. If the distance is smaller than a predetermined distance threshold, the control unit 210 may acquire the first data sequence, and if the distance is larger than or equal to the predetermined distance threshold, the control unit 210 may acquire the second data sequence. Namely, the control unit 210 may acquire the selected data sequence from the earth station 50 based on the distance between the user satellite 100 and the relay satellite 200.

Specifically, if the user satellite 100 is located near the relay satellite 200, the earth station 50 may transmit the first predictive ephemeris data sequence with a higher temporal resolution to the relay satellite 200, and the control unit 210 may interpolate the first predictive ephemeris data sequence to estimate the orbit of the user satellite 100. On the other hand, if the user satellite 100 is located far away from the relay satellite 200, the earth station 50 may transmit the second predictive ephemeris data sequence with a lower temporal resolution to the relay satellite 200, and the control unit 210 may interpolate the second predictive ephemeris data sequence to estimate the orbit of the user satellite 100 with a high accuracy.

According to this embodiment, the relay satellite 200 may acquire the data sequence that is properly switched based on the distance between the user satellite 100 and the relay satellite 200.

In one embodiment, the predetermined selection criteria may be associated with the communication state between the earth station 50 and the relay satellite 200. If the communication state is lower than a predetermined quality threshold, the control unit 210 may acquire the second data sequence, and if the communication state is higher than or equal to the predetermined quality threshold, the control unit 210 may acquire the first data sequence. Namely, the control unit 210 may acquire the data sequence that is selected based on the communication state between the earth station 50 and the relay satellite 200.

Specifically, if the communication state between the earth station 50 and the relay satellite 200 is not good, there is a likelihood that a larger amount of data sequence cannot be successfully transmitted to the relay satellite 200. Accordingly, the earth station 50 may transmit the second predictive ephemeris data sequence with a lower temporal resolution to the relay satellite 200 (for example, iterative transmissions), and the control unit 210 may acquire the data sequence more reliably. On the other hand, if the communication state between the earth station 50 and the relay satellite 200 is good, it is expected that a larger amount of data sequence can be successfully transmitted to the relay satellite 200. Accordingly, the earth station 50 may transmit the first prediction ephemeris data sequence with a higher temporal resolution to the relay satellite 200, and the control unit 210 may perform interpolation on the first predictive ephemeris data sequence for estimation of the orbit of the user satellite 100 with a high accuracy.

According to this embodiment, the relay satellite 200 may acquire the predictive ephemeris data sequence that is properly switched based on the communication state between the earth station 50 and the relay satellite 200.

In one embodiment, the predetermined selection criteria may be associated with the capability of the relay satellite 200. If the capability is lower than a predetermined calculation capability level threshold, the control unit 210 may acquire the first predictive ephemeris data sequence, and if the capability is higher than or equal to the predetermined capability level threshold, the control unit 210 may acquire the second predictive ephemeris data sequence. Here, the capability of the relay satellite 200 may include a calculation capability, a storage capacity, a communication capability with the earth station 50, a capability of the optical communication system 103A for communicating with the user satellite 100 or the like, for example. Namely, the control unit 210 may acquire the predictive ephemeris data sequence that is selected based on the capability of the relay satellite 200.

Specifically, if the calculation capability of the relay satellite 200 is relatively low, there is a likelihood that the relay satellite 200 may not be able to process or utilize the predictive ephemeris data sequence with a low temporal resolution. Accordingly, the earth station 50 may transmit the first predictive ephemeris data sequence with a higher temporal resolution to the relay satellite 200, and the control unit 210 may estimate the orbit of the user satellite 100 based on the first prediction ephemeris data sequence without use of the relatively high capability. On the other hand, if the capability of the relay satellite 200 is relatively high, there is a likelihood that the relay satellite 200 may be able to process or utilize the predictive ephemeris data sequence with a lower temporal resolution. Accordingly, the earth station 50 may transmit the second predictive ephemeris data sequence with a lower temporal resolution to the relay satellite 200, and the control unit 210 may estimate the orbit of the user satellite 100 based on the second predictive ephemeris data sequence with a high accuracy by utilizing the relatively high capability.

According to this embodiment, the relay satellite 200 may acquire the data sequence that is properly switched based on the capability of the relay satellite 200 can be acquired.

In one embodiment, the predetermined selection criteria may be associated with a remaining computing power of the relay satellite 200. If the remaining computing power is smaller than a predetermined threshold, the control unit 210 may acquire the first predictive ephemeris data sequence, and if the remaining computing power is greater than or equal to the predetermined threshold, the control unit 210 may acquire the second predictive ephemeris data sequence. Namely, the control unit 210 may acquire the predictive ephemeris data sequence that is selected based on the remaining computing power of the relay satellite 200.

Specifically, if the remaining computing power of the relay satellite 200 is relatively low, there is a likelihood that the relay satellite 200 may not be able to perform interpolation on the predictive ephemeris data sequence with a low temporal resolution. Accordingly, the earth station 50 may transmit the first predictive ephemeris data sequence with a higher temporal resolution to the relay satellite 200, and the control unit 210 may estimate the orbit of the user satellite 100 based on the first predictive ephemeris data sequence without use of a higher calculation load. On the other hand, if the remaining computing power of the relay satellite 200 is relatively high, it can be considered that the relay satellite 200 can process the predictive ephemeris data sequence with a low temporal resolution. Accordingly, the earth station 50 may transmit the second predictive ephemeris data sequence with a lower temporal resolution to the relay satellite 200, and the control unit 210 may estimate the orbit of the user satellite 100 based on the second predictive ephemeris data sequence with a high accuracy with use of the relatively high remaining computing power.

According to this embodiment, the relay satellite 200 may acquire the data sequence that is properly switched based on the remaining computing power of the relay satellite 200 can be acquired.

### Communication Operation

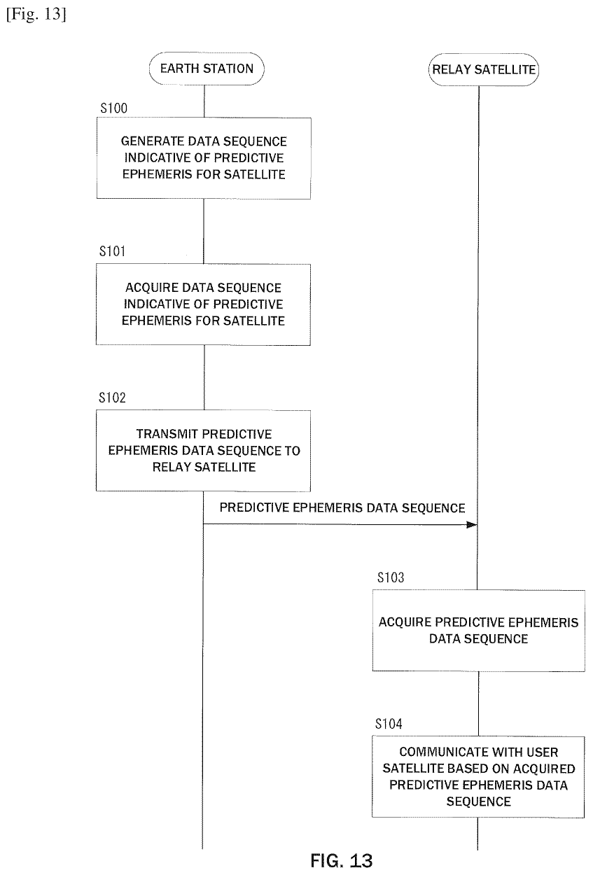

Next, a communication operation according to one embodiment of the present disclosure is described with reference to FIG. 13. The communication operation may be performed by the earth station 50 and the relay satellite 200. FIG. 13 is a sequence diagram for illustrating a communication operation according to one embodiment of the present disclosure.

As illustrated in FIG. 13, at step S100, the earth station 50 calculates a predictive ephemeris data sequence for the user satellite 100 and/or the relay satellite 200 through correction of influences caused by perturbation factors in addition to Keplerian six orbit elements included in TLE to generate predictive ephemeris data with a higher accuracy than conventional method. Also, the relay satellite operator 30 or the user satellite operator 40 may calculate and generate the respective predictive ephemeris data sequences.

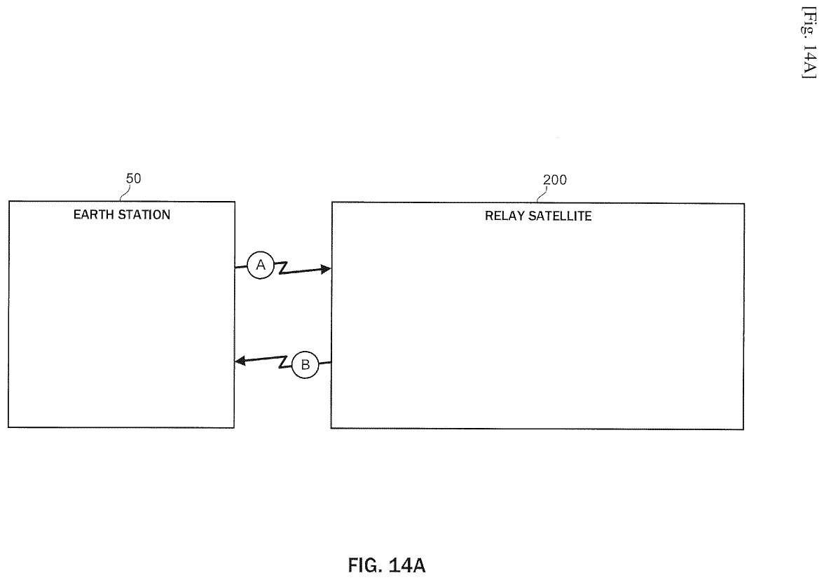

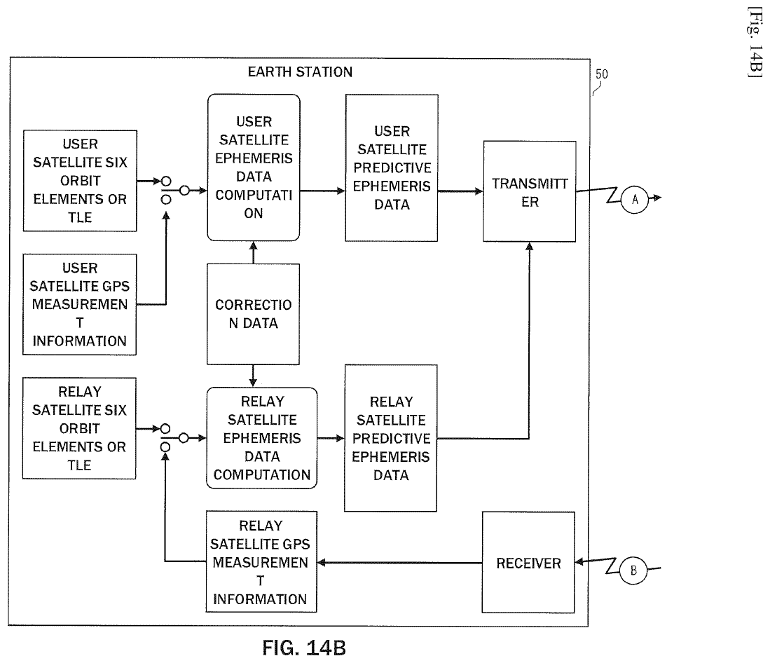

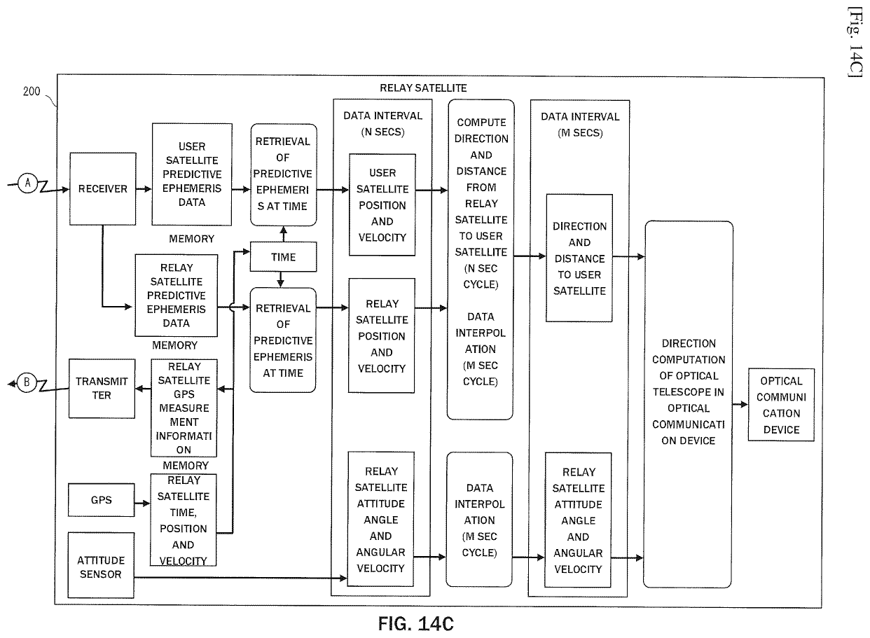

FIGS. 14A to 14C are block diagrams for illustrating the communication operation between the earth station 50 and the relay satellite 200 according to one embodiment of the present disclosure. As illustrated in FIG. 14A, the earth station 50 and the relay satellite 200 perform wireless communication via radio waves or the like. For example, as illustrated in FIG. 14B, the earth station 50 may calculate predictive ephemeris data of the user satellite 100 based on the six orbit elements or TLE and GPS positioning information for the user satellite 100 whereas the earth station 50 may calculate predictive ephemeris data for the relay satellite 200 based on the six orbit elements or TLE and GPS positioning information for the relay satellite 200. Note that the earth station 50 according to the present disclosure, but is not limited to it, may acquire the prediction ephemeris data for the relay satellite 200 and/or the user satellite 100 calculated by the relay satellite operator 30 and/or the user satellite operator 40. Then, the earth station 50 may transmit the calculated predictive ephemeris data for the user satellite 100 and/or the relay satellite 200 to the relay satellite 200.

Upon receiving the predictive ephemeris data for the relay satellite 200 and/or the user satellite 100 from the earth station 50, the relay satellite 200 may determine the position and velocity of the relay satellite 200 and/or the user satellite 100 at a target time instant based on the received predictive ephemeris data and calculate the direction and distance to the user satellite 100 through data interpolation. In parallel to the above, the relay satellite 200 may also measure the attitude angle and/or angular velocity of the relay satellite 200 by means of an attitude sensor or the like and calculate the attitude angle and angular velocity to the user satellite 100 through data interpolation. Then, the relay satellite 200 adjusts the orientation of the optical communication device 103A based on the direction, the distance, the attitude angle and/or the angular velocity to the user satellite 100 and emits an optical signal.

At step S101, the earth station 50 acquires a data sequence indicative of a predicted ephemeris for the user satellite 100 and/or the relay satellite 200. Specifically, the earth station 50 may calculate a predictive ephemeris data sequence for the user satellite 100 (or the relay satellite 200) with a high accuracy based on Keplerian six orbit elements or GPS positioning information received from the user satellite 100 (or the relay satellite 200) in downlinks and by taking into account perturbation factors. The Keplerian six orbit elements may be derived from information included in TLE. Also, the predictive ephemeris data sequence may be generated by the relay satellite operator 30 or the user satellite operator 40, and the earth station 50 may acquire the predictive ephemeris data sequence from the relay satellite operator 30 and/or the user satellite operator 40 via the network 20 such as the Internet. Also, the earth station 50 may acquire a first predictive ephemeris data sequence having a first data amount and a second predictive ephemeris data sequence having a second data amount smaller than the first data amount. In one embodiment, the first predictive ephemeris data sequence may be a first prediction ephemeris data sequence with a first temporal resolution for the user satellite 100, and the second predictive ephemeris data sequence may be a second predictive ephemeris data sequence with a second temporal resolution lower than the first temporal resolution for the user satellite 100. Note that the earth station 50 may acquire a data sequence that is selected from the first predictive ephemeris data sequence and the second predictive ephemeris data sequence in accordance with predetermined selection criteria, instead of acquiring both the first predictive ephemeris data sequence and the second predictive ephemeris data sequence. Also, the first predictive ephemeris data sequence or the second predictive ephemeris data sequence that is selected by the relay satellite operator 30 or the user satellite operator 40 may be transmitted to the earth station 50 via the network such as the Internet.

At step S102, the earth station 50 transmits the predictive ephemeris data sequence to the relay satellite 200. Also, if the earth station 50 acquires the first predictive ephemeris data sequence and the second predictive ephemeris data sequence, the earth station 50 may transmit a data sequence that is selected from the first predictive ephemeris data sequence and the second predictive ephemeris data sequence in accordance with predetermined selection criteria as orbit information of the user satellite 100 to the relay satellite 200. For example, the earth station 50 may identify the selected data sequences for the respective user satellites 100 covered by the relay satellite 200 and transmit the set of data sequences identified as for transmission to the relay satellite 200. Also, at step S102, the earth station 50 may transmit the predictive ephemeris data to the user satellite 100. Also, at step S102, the earth station 50 may transmit the predictive ephemeris data sequence of the relay satellite 200 that is selected from the first predictive ephemeris data sequence and the second predictive ephemeris data sequence in accordance with the predetermined selection criteria as the orbit information of the relay satellite 200 to the user satellite 100.

In one embodiment, the predetermined selection criteria may be associated with the distance between the user satellite 100 and the relay satellite 200, the communication state between the earth station 50 and the relay satellite 200, the capability of the relay satellite 200 and/or the remaining computing power of the relay satellite 200. Note that these selection criteria may be combined. Also, the data sequence may be selected by the earth station 50. Alternatively, a selection instruction may be received from other entities such as the relay satellite operator 30 or the user satellite operator 40.

At step S103, the relay satellite 200 acquires the predictive ephemeris data sequence. Specifically, the relay satellite 200 may receive the predictive ephemeris data sequence for the user satellite 100 and/or the relay satellite 200 from the earth station 50. Also, the relay satellite 200 may acquire, from the earth station 50, a data sequence that is selected from the first predictive ephemeris data sequence and the second predictive ephemeris data sequence in accordance with the predetermined selection criteria. For example, if the relay satellite 200 covers the plurality of user satellites 100, the relay satellite 200 may acquire the respective predictive ephemeris data sequences for each of the plurality of user satellite 100. Also, at step S103, the user satellite 100 may acquire the predictive ephemeris data sequence for the relay satellite 200 and/or the user satellite 100 from the earth station 50.

At step S104, the relay satellite 200 performs inter-satellite optical communication with the user satellite 100 based on the acquired predictive ephemeris data sequence. Specifically, the relay satellite 200 may estimate the orbit of the user satellite 100 based on the acquired predictive ephemeris data sequence of the user satellite 100 and transmit an optical beacon toward the estimated position of the user satellite 100. Upon receiving the optical beacon, the user satellite 100 may establish a communication connection with the relay satellite 200 and transmit and receive communication light to exchange data.

According to the above-stated embodiments, instead of calculation of a predicted orbit for the user satellite 100 at the relay satellite 200 receiving Keplerian six orbit elements in accordance with conventional techniques, the earth station 50, the relay satellite operator 30 or the user satellite operator 40 can calculate more accurate predictive ephemeris data required for inter-satellite optical communication with the user satellite 100 and provide the derived predictive ephemeris data to the relay satellite 200. In this manner, even in the case where the relay satellite 200 has a limited calculation capability, the relay satellite 200 can conduct the inter-satellite optical communication with the user satellite 100 properly by using orbit data obtained from the earth station 50. Also, an appropriate data amount of data sequences can be provided to the relay satellite 200 based on the distance between the user satellite 100 and the relay satellite 200, the communication state between the earth station 50 and the relay satellite 200, the capability of the relay satellite 200 and/or the remaining computing power of the relay satellite 200.

Although the above embodiments have been described in conjunction with predictive ephemeris data sequences with two different data amounts or different temporal resolutions such as the first predictive ephemeris data sequence and the second predictive ephemeris data sequence, the present disclosure is not limited to the embodiments and can be applied to predictive ephemeris data sequences with three or more different data amounts or different temporal resolutions. Also, a predictive position data sequence for the user satellite 100 has been focused on as the predictive ephemeris data sequence, but the present disclosure is not limited to it and may be applied to any other data for transmission from the earth station 50 to the relay satellite 200 or the user satellite 100.

Note that the following appendices are further disclosed in conjunction with the above description.

### Appendix 1

An earth station, comprising:
a data acquisition unit that acquires a predicted orbit data sequence indicative of a predictive ephemeris of a satellite; and
a communication unit that transmits the acquired predicted orbit data sequence to a relay satellite.

### Appendix 2

The earth station as claimed in appendix 1, wherein the predicted orbit data sequence is calculated in consideration of a perturbation factor.

### Appendix 3

The earth station as claimed in appendix 2, wherein the data acquisition unit acquires a first data sequence that is the predicted orbit data sequence having a first data amount and a second data sequence that is the predicted orbit data sequence having a second data amount smaller than the first data amount, and the communication unit transmits the first data sequence or the second data sequence as orbit information of a satellite to a relay satellite, the first data sequence or the second data sequence selected in accordance with predetermined selection criteria.

### Appendix 4

The earth satellite as claimed in appendix 2, wherein the data acquisition unit acquires a first data sequence that is the predicted orbit data sequence having a first temporal resolution and a second data sequence that is the predicted orbit data sequence having a second temporal resolution lower than the first temporal resolution, and the communication unit transmits the first data sequence or the second data sequence as orbit information of a satellite to a relay satellite, the first data sequence or the second data sequence selected in accordance with predetermined selection criteria.

### Appendix 5

The earth station as claimed in appendix 3 or 4, wherein the predetermined selection criteria is associated with a distance between the satellite and the relay satellite, and if the distance is smaller than a predetermined distance threshold, the communication unit transmits the first data sequence as the orbit information to the relay satellite, and if the distance is greater than or equal to the predetermined distance threshold, the communication unit transmits the second data sequence as the orbit information to the relay satellite.

### Appendix 6

The earth station as claimed in appendix 3 or 4, wherein the predetermined selection criteria is associated with a communication state between the earth station and the relay satellite, and if the communication state is lower than a predetermined quality threshold, the communication unit transmits the second data sequence as the orbit information to the relay satellite, and if the communication state is higher than or equal to the predetermined quality threshold, the communication unit transmits the first data sequence as the orbit information to the relay satellite.

### Appendix 7

The earth station as claimed in appendix 3 or 4, wherein the predetermined selection criteria is associated with a capability of the relay satellite, and if the capability is lower than a predetermined capability level threshold, the communication unit transmits the second data sequence as the orbit information to the relay satellite, and if the capability is higher than or equal to the predetermined capability level threshold, the communication unit transmits the first data sequence as the orbit information to the relay satellite.

### Appendix 8

The earth station as claimed in appendix 3 or 4, wherein the predetermined selection criteria is associated with a remaining computing power of the relay satellite, and if the remaining computing power is smaller than a predetermined threshold, the communication unit transmits the second data sequence as the orbit information to the relay satellite, and if the remaining computing power is greater than or equal to the predetermined threshold, the communication unit transmits the first data sequence as the orbit information to the relay satellite.

### Appendix 9

A communication method performed by an earth station, comprising:
acquiring a prediction orbit data sequence indicative of a predictive ephemeris of a satellite; and
transmitting the acquired predicted orbit data sequence to a relay satellite.

### Appendix 10

The communication method as claimed in appendix 9, wherein the predicted orbit data sequence is calculated in consideration of a perturbation factor.

### Appendix 11

A relay satellite, comprising:
a control unit that acquires a predicted orbit data sequence indicative of a predictive ephemeris of a satellite from an earth station; and
an optical communication unit that performs inter-satellite optical communication with a satellite based on the acquired predicted orbit data sequence.

### Appendix 12

The relay satellite as claimed in appendix 11, wherein the predicted orbit data sequence is calculated in consideration of a perturbation factor.

### Appendix 13

The relay satellite as claimed in appendix 12, wherein the control unit acquires a data sequence from the earth station, the data sequence selected from a first data sequence or a second data sequence in accordance with predetermined selection criteria, and the first data sequence is the predicted orbit data sequence having a first data amount, and the second data sequence is the predicted orbit data sequence having a second data amount smaller than the first data amount.

### Appendix 14

The relay satellite as claimed in appendix 12, wherein the control unit acquires a data sequence from the earth station, the data sequence selected from a first data sequence or a second data sequence in accordance with predetermined selection criteria, and the first data sequence is the predicted orbit data sequence having a first temporal resolution, and the second data sequence is the predicted orbit data sequence having a second temporal resolution lower than the first temporal resolution.

### Appendix 15

The relay satellite as claimed in appendix 13 or 14, wherein the predetermined selection criteria is associated with a distance between the satellite and the relay satellite, and if the distance is smaller than a predetermined distance threshold, the control unit acquires the first data sequence, and if the distance is greater than or equal to the predetermined distance threshold, the control unit acquires the second data sequence.

### Appendix 16

The relay satellite as claimed in appendix 13 or 14, wherein the predetermined selection criteria is associated with a communication state between the earth station and the relay satellite, and if the communication state is lower than a predetermined quality threshold, the control unit acquires the second data sequence, and if the communication state is higher than or equal to the predetermined quality threshold, the control unit acquires the first data sequence.

### Appendix 17

The relay satellite as claimed in appendix 13 or 14, wherein the predetermined selection criteria is associated with a capability of the relay satellite, and if the capability is lower than a predetermined capability level threshold, the control unit acquires the second data sequence, and if the capability is higher than or equal to the predetermined capability level threshold, the control unit acquires the first data sequence.

### Appendix 18

The relay satellite as claimed in appendix 13 or 14, wherein the predetermined selection criteria is associated with a remaining computing power of the relay satellite, and if the remaining computing power is smaller than a predetermined threshold, the control unit acquires the second data sequence, and if the remaining computing power is greater than or equal to the predetermined threshold, the control unit acquires the first data sequence.

### Appendix 19

A communication method performed by a relay satellite, comprising:
acquiring a predicted orbit data sequence indicative of a predictive ephemeris of a satellite from an earth station; and
performing inter-satellite optical communication with a satellite based on the acquired predicted orbit data sequence.

### Appendix 20

A satellite system, comprising:
an earth station;
a satellite; and
a relay satellite that relays between the earth station and the satellite,
wherein the earth station acquires a predicted orbit data sequence indicative of a predictive ephemeris of the satellite and transmits the acquired predicted orbit data sequence to the relay satellite.

Although the embodiments of the present disclosure have been described in detail above, the present disclosure is not limited to the above-stated certain embodiments, various variations and alterations can be made within the spirit of the present disclosure as recited in the claims.

The disclosure of Japanese Patent Application No.2022-111267, filed on Jul. 11, 2022, including the specification, drawings and abstract, is incorporated herein by reference in its entirety.

### REFERENCE SIGNS LIST

10. Satellite system
50. Earth station
51: Data acquisition unit
52: Communication unit
100: User satellite
200: Relay satellite
210: Control unit
220: Processing unit
230: Optical communication unit

1. An earth station, comprising:
a data acquisition unit that acquires a predicted orbit data sequence indicative of a predictive ephemeris of a satellite for a predetermined period; and
a communication unit that transmits the acquired predicted orbit data sequence to a relay satellite, p1 wherein the data acquisition unit acquires a first data sequence that is the predicted orbit data sequence having a first data amount and a second data sequence that is the predicted orbit data sequence having a second data amount smaller than the first data amount, and the communication unit transmits the first data sequence or the second data sequence as orbit information of a satellite to a relay satellite, the first data sequence or the second data sequence selected in accordance with predetermined selection criteria.

2. The earth satellite as claimed in claim 1, wherein the data acquisition unit acquires a first data sequence that is the predicted orbit data sequence having a first temporal resolution and a second data sequence that is the predicted orbit data sequence having a second temporal resolution lower than the first temporal resolution.

3. The earth station as claimed in claim 1, wherein the first data sequence or the second data sequence is the predicted orbit data sequence computed by taking into account a perturbation factor.

4. The earth station as claimed in claim 1, wherein the communication unit supports a plurality of transmission data rates for transmission of the predicted orbit data sequence to the satellite.

5. The earth station as claimed in claim 1, wherein the predetermined selection criteria is associated with a distance between the satellite and the relay satellite, and if the distance is smaller than a predetermined distance threshold, the communication unit transmits the first data sequence as the orbit information to the relay satellite, and if the distance is greater than or equal to the predetermined distance threshold, the communication unit transmits the second data sequence as the orbit information to the relay satellite.

6. The earth station as claimed in claim 1, wherein the predetermined selection criteria is associated with a communication state between the earth station and the relay satellite, and if the communication state is lower than a predetermined quality threshold, the communication unit transmits the second data sequence as the orbit information to the relay satellite, and if the communication state is higher than or equal to the predetermined quality threshold, the communication unit transmits the first data sequence as the orbit information to the relay satellite.

7. The earth station as claimed in claim 1, wherein the predetermined selection criteria is associated with a capability of the relay satellite, and if the capability is lower than a predetermined capability level threshold, the communication unit transmits the second data sequence as the orbit information to the relay satellite, and if the capability is higher than or equal to the predetermined capability level threshold, the communication unit transmits the first data sequence as the orbit information to the relay satellite.

8. The earth station as claimed in claim 1, wherein the predetermined selection criteria is associated with a remaining computing power of the relay satellite, and if the remaining computing power is smaller than a predetermined threshold, the communication unit transmits the second data sequence as the orbit information to the relay satellite, and if the remaining computing power is greater than or equal to the predetermined threshold, the communication unit transmits the first data sequence as the orbit information to the relay satellite.

9. A communication method performed by an earth station, comprising:
acquiring a predicted orbit data sequence indicative of a predictive ephemeris of a satellite for a predetermined period; and
transmitting the acquired predicted orbit data sequence to a relay satellite,
wherein the acquiring includes acquiring a first data sequence that is the predicted orbit data sequence having a first data amount and a second data sequence that is the predicted orbit data sequence having a second data amount smaller than the first data amount, and the transmitting includes transmitting the first data sequence or the second data sequence as orbit information of a satellite to a relay satellite, the first data sequence or the second data sequence selected in accordance with predetermined selection criteria.

10. The communication method as claimed in claim 9, wherein the first data sequence is the predicted orbit data sequence having a first temporal resolution and the second data sequence is the predicted orbit data sequence having a second temporal resolution lower than the first temporal resolution.

11. The communication method as claimed in claim 9, wherein the first data sequence or the second data sequence is the predicted orbit data sequence computed by taking into account a perturbation factor.

12. The communication method as claimed in claim 9, wherein a plurality of transmission data rates are supported for transmission of the predicted orbit data sequence to the relay satellite.

13. The communication method as claimed in claim 9, wherein the predicted orbit data sequence is computed by taking into account a perturbation factor.

14. A relay satellite, comprising:
a control unit that acquires a predicted orbit data sequence indicative of a predictive ephemeris of a satellite for a predetermined period from an earth station; and
an optical communication unit that performs inter-satellite optical communication with a satellite based on the acquired predicted orbit data sequence,
wherein the control unit acquires a first data sequence or a second data sequence selected in accordance with predetermined selection criteria from the earth station, and the first data sequence is the predicted orbit data sequence having a first data amount and a second data sequence is the predicted orbit data sequence having a second data amount smaller than the first data amount.

15. The relay satellite as claimed in claim 14, wherein the first data sequence is the predicted orbit data sequence having a first temporal resolution and the second data sequence is the predicted orbit data sequence having a second temporal resolution lower than the first temporal resolution.

16. The relay satellite as claimed in claim 14, wherein the first data sequence or the second data sequence is computed by taking into account a perturbation factor.

17. The relay satellite as claimed in claim 14, wherein the predetermined selection criteria is associated with a distance between the satellite and the relay satellite, and if the distance is smaller than a predetermined distance threshold, the control unit acquires the first data sequence, and if the distance is greater than or equal to the predetermined distance threshold, the control unit acquires the second data sequence.

18. The relay satellite as claimed in claim 14, wherein the predetermined selection criteria is associated with a communication state between the earth station and the relay satellite, and if the communication state is lower than a predetermined quality threshold, the control unit acquires the second data sequence, and if the communication state is higher than or equal to the predetermined quality threshold, the control unit acquires the first data sequence.

19. The relay satellite as claimed in claim 14, wherein the predetermined selection criteria is associated with a capability of the relay satellite, and if the capability is lower than a predetermined capability level threshold, the control unit acquires the second data sequence, and if the capability is higher than or equal to the predetermined capability level threshold, the control unit acquires the first data sequence.

20. The relay satellite as claimed in claim 14, wherein the predetermined selection criteria is associated with a remaining computing power of the relay satellite, and if the remaining computing power is smaller than a predetermined threshold, the control unit acquires the second data sequence, and if the remaining computing power is greater than or equal to the predetermined threshold, the control unit acquires the first data sequence.

21. A communication method performed by a relay satellite, comprising:
acquiring a predicted orbit data sequence indicative of a predictive ephemeris of a satellite for a predetermined period from an earth station; and
performing inter-satellite optical communication with a satellite based on the acquired predicted orbit data sequence,
wherein the acquiring includes acquiring a first data sequence or a second data sequence selected at the earth station in accordance with predetermined selection criteria from the earth station, and the first data sequence is the predicted orbit data sequence having a first data amount and a second data sequence is the predicted orbit data sequence having a second data amount smaller than the first data amount.

22. A satellite system, comprising:
an earth station;
a satellite; and
a relay satellite that relays between the earth station and the satellite,
wherein the earth station acquires a predicted orbit data sequence indicative of a predictive ephemeris of a satellite for a predetermined period and transmits the acquired predicted orbit data sequence to a relay satellite,
wherein the earth station acquires a first data sequence that is the predicted orbit data sequence having a first data amount and a second data sequence that is the predicted orbit data sequence having a second data amount smaller than the first data amount and transmits the first data sequence or the second data sequence as orbit information to the relay satellite, the first data sequence or the second data sequence selected in accordance with predetermined selection criteria.
